(19) United States
(12) Patent Application Publication
(10) Pub. No.: US 2018/0292568 A1
(43) Pub. Date: Oct. 11, 2018

(54) OPTICAL PROXIMITY SENSOR WITH A SELF-INTEGRATED BARRIER

(71) Applicant: DAPA, INC., Taouan City (TW)

(72) Inventor: TING-YI CHEN, TAOYUAN CITY (TW)

(21) Appl. No.: 15/616,145

(22) Filed: Jun. 7, 2017

(30) Foreign Application Priority Data
Apr. 11, 2017 (TW) 106112059

(51) Int. Cl. G01V 8/14; G01S 17/02; G01S 7/497; G01S 7/02; G01S 7/481; G01S 7/486

(52) U.S. Cl. CPC G01V 8/14; G01S 17/026; G01S 7/4861; G01S 7/023; G01S 7/4816; G01S 7/4972

(57) ABSTRACT

A complex optical proximity sensor has a vertical-cavity surface emitting laser (VCSEL), an ambient lights detection chip, and a proximity sensor (PS) arranged in linear alignment to form a self-integrated barrier within the structure. The PS only receives lights with a first wavelength and a first energy and the ambient lights detection chip solely receives lights with a second wavelength and a second energy to prevent the VCSEL from interfering with the PS. Meanwhile, the arrangement has the ambient lights detection chip disposed in a middle section of an oblong opening to maximize a detection angle of ambient lights.

### BACKGROUND OF THE INVENTION

### 1. Field of the Invention

The invention relates to an optical proximity sensor that prevents a vertical-cavity surface-emitting laser thereof from interfering with a proximity sensor thereof and that maximizes a detection angle of ambient lights for the device.

### 2. Description of the Related Art

Smart mobile devices such as smartphones usually have an ambient light sensor (ALS) for ambient light detection to adjust brightness of the touchscreen for energy-saving; such devices also have a proximity sensor (PS) and a light emitter for proximity detection to automatically close the touchscreen in case of inadvertent operations when a user's face is close to the touchscreen during a phone call. The ALS and PS are both applications of light detection and therefore can be integrated into one package with the light emitter for less space for installation, less manufacturing materials, and for combined arrangement for circuits. The ALS and PS are usually disposed at a side a display panel of a smart mobile device, and ALS detects an angle wider than PS does. However, when the ALS and PS are closely disposed and encapsulated within a package, the detection angle of ALS will be restricted by the detection angle of PS.

FIG. 1A is disclosed in U.S. Pat. No. 9,046,415 owned by Apple Inc. The invention is a complex detection apparatus 10 with ALS and PS structures, mainly including a light emitting compartment 11, a light receiving compartment 13, and a reflection element 14, all of which being disposed on a substrate 12. The light emitting compartment 11 has a light emitter 111 and an optical element 112 coupled to a PS circuitry 111a and disposed at an opposite side to the light emitter 111 for proximity detection. The light receiving compartment 13 has a light detector 121 connected to a proximity sensor circuitry 121a and an ALS circuitry 121b disposed at an opposite side to the light detector 121. The reflection element 14 is disposed in the light receiving compartment 13 on a middle wall 123 which is arranged perpendicularly to the substrate 12 thereon. The reflection element 14 reflects an off-axis light beam to the light detector 121 to form an image thereon of a virtual image formed behind the reflection element 14. The complex detection apparatus 10 is disposed inside an iPhone 4 16 under an oblong hole 161 thereof as shown in FIG. 1B. However, such structure cannot detect instantly and therefore fails to disable the touchscreen now and then.

FIGS. 2A and 2B shows appearance of an iPhone 6 Plus 20 and two openings 22, 23 for a corresponding ALS structure 40 and a corresponding PS structure 21. FIGS. 2C and 2D shows appearance of an iPhone 7 Plus 30 and two openings 32, 33 for a corresponding ALS structure 40 and a corresponding PS structure 31. From the appearances, the position arrangement of the openings 22, 23, 32, 33 are different in different devices; in view of internal structures, the PS structures 21, 31 of the devices are different as well.

As shown in FIG. 2E, a PS structure 21 installed on the iPhone 6 Plus 20 is a common package. The package includes a light emitting chip 211, a light receiving chip 212, and an isolating package 213; the isolating package 213 does not include an ASIC chip. Such structure is installed corresponding to the opening 23 under a glass layer 24 thereof. The isolating package 213 functions as a barrier, and when the light emitting chip 211 emits lights to an object O and when the lights are reflected to the light receiving chip 212 at an angle θₐ₁, the lights would be reflected by a first surface 241 of the glass layer 24 at a first reflection angle θₙ₁, producing a first optical noise, and by a second surface 242 of the glass layer 24 at a second reflection angle θₙ₂, producing a second optical noise.

A PS structure 31 of iPhone 7 Plus is illustrated in FIG. 2F which is disclosed in U.S. Pat. No. 9,525,094. The PS structure 31 includes a substrate 311, a semiconductor die 314, a light emitting device 317, and a cover 319. The substrate 311 includes a plurality of first contact pads 312 on a first surface thereof and a plurality of second contact pads 313 on a second surface thereof. The semiconductor die 314 has a sensor area 315 and a plurality of third contact pads 316 all on an upper surface thereof. The light emitting device 317 includes a plurality of fourth contact pads 318 and is disposed on the upper surface of the semiconductor die 314. The cover 319 has a first aperture 319a arranged above the light emitting device 317, a second aperture 319b arranged above the sensor area 315 of the semiconductor die 314, and a light barrier 319c disposed in-between the light emitting device 317 and the sensor area 315 of the semiconductor die 314; the cover 319 is fixed on the substrate 311.

The PS structure 31 is installed on an iPhone 7 Plus 30 corresponding to the opening 33 under a glass layer 34. However, when the light emitting device 317 emits lights at an angle θₐ₂, a first optical noise is produced by lights emitted to an object O and reflected by a first surface 341 of the glass layer 34 at a first reflection angle θₙ₁ and a second optical noise is produced by lights emitted to the object O and reflected by a second surface 342 of the glass layer 34 at a second reflection angle θₙ₂. In other words, there are still interferences with operation of detection.

Another PS structure 41 is shown in FIG. 2G, disclosed in U.S. Pat. No. 9,543,282. The structure includes a first substrate 411, an image sensor processor die 412 coupled to the first substrate 411, an encapsulated material 413 disposed surrounding the image sensor processor die 412, a second substrate 414 disposed on the image sensor processor die 412, a third substrate 415 disposed on the image sensor processor die 412, a LED die 416 disposed on the second substrate 414, a photodiode die 417 disposed on the third substrate 415, and a cap 418 including a side wall 418a and an internal wall 418b separating the LED die 416 and the photodiode die 417. The cap 418 further covers the structure with a first through hole 419a exposing the LED die 416 and a second through hole 419b exposing the photodiode die 417. In such structure, the internal wall 418b functions as a barrier; however, such structure produces optical noises too.

On the other hand, both iPhone 6 Plus and 7 Plus has an ALS structure 42 installed thereon as presented in FIG. 2H. The ALS structure 42 includes a substrate 421, an ambient light detection chip 422 disposed on the substrate 421, a transparent package 423 disposed on the substrate 421 for encapsulating the ambient light detection chip 422, in order to maximize an detection angle of ambient lights S. If integrating the ALS structure 42 with the PS structures mentioned above, the barrier within the structures—the isolating package 213, light barrier 319c, the internal wall 418b—would interfere with detection of the ALS structure 42. Therefore, we can learn that combining PS structure with ALS structure is not a feature Apple Inc., possesses.

Although structures with separate PS and ALS detect better, they cost higher prime costs as well. Also, such structures require two openings on the device for corresponding explosion for detection. Therefore, it is desirable to integrate PS and ALS structures while keeps the same effectiveness of detection.

### SUMMARY OF THE INVENTION

It is a primary objective of the present invention to provide a complex optical proximity sensor with a self-integrated barrier that includes an ambient lights detection chip as an independent ambient lights sensor (ALS) and a proximity sensor structure composed of a vertical-cavity surface-emitting laser (VCSEL) and a proximity sensor (PS). The ALS being the barrier prevents the VCSEL from interfering with the PS and maximizes a detection angle of ambient lights.

In order to achieve the objectives above, the complex optical proximity sensor to be installed in a mobile device under an opening hole comprises a substrate; an application-specific integrated circuit (ASIC) chip coupled to the substrate and connected to a proximity sensor thereon; a vertical-cavity surface-emitting laser coupled to the substrate in linear alignment with the proximity sensor, said vertical-cavity surface-emitting laser emitting laser beam with a first wavelength and a first energy received by the proximity sensor; an ambient lights detection chip manufactured separately and then coupled to the application-specific integrated circuit chip, said ambient lights detection chip receiving lights with a second wavelength and a second energy, wherein the ambient lights detection chip stands a pre-determined height independently on the application-specific integrated circuit chip and is disposed between the vertical-cavity surface-emitting laser and the proximity sensor in linear alignment, forming a self-integrated barrier in-between the vertical-cavity surface-emitting laser and the proximity sensor; and a package body encapsulating the application-specific integrated circuit chip, proximity sensor, vertical-cavity surface-emitting laser, and ambient lights detection chip on the substrate, said package body including an oblong hole in a middle section at a top thereof to expose the ambient lights detection chip.

Advantageously, the first wavelength is 940 nm and the second wavelength is 550 nm; the package body is a cap.

In addition, the package body may include a transparent package filling up the oblong hole and covering the application-specific integrated circuit chip, proximity sensor, vertical-cavity surface-emitting laser, and ambient lights detection chip within the package body; the transparent package may be a lens.

Furthermore, the ambient lights detection chip detects ambient lights, RGB lights, or UV lights. The substrate is either a ceramic substrate or a PCB for the application-specific integrated circuit chip and the vertical-cavity surface emitting laser to be connected by coupling, and the application-specific integrated circuit chip has a plurality of first connect points coupled to a plurality of corresponding second connect points on the ambient lights detection chip. The substrate may further include a plurality of bond pads arranged under a bottom thereof to be coupled to the application-specific integrated circuit chip and the vertical-cavity surface emitting laser, making the complex optical proximity sensor a surface-mount device.

Also, the proximity sensor is connected to the application-specific integrated circuit chip either by coupling or installation.

The oblong hole has a length and a width arranged less than a diameter of the opening hole and the ambient lights detection chip is exposed at a center of the oblong hole as the self-integrated barrier, displaying a symmetric detection angle about the ambient lights detection chip.

As stated above, the ambient light detection chip stands independently on the ASIC chip with a pre-determined height to form a self-integrated barrier between the VCSEL and the PS for prevention from interferences with the PS and for maximizing a detection angle for ambient lights. In addition, the VCSEL and the ambient lights detection chip are set to receive lights with different wavelength and different energies to further ensure prevention from interferences with the PS.

### BRIEF DESCRIPTION OF THE DRAWINGS

FIG. 1A is a schematic diagram showing a conventional structure of a complex sensor with ambient lights sensor and a proximity sensor;

FIG. 1B is a perspective view of an iPhone 4 with the complex sensor installed therein.

FIG. 2A is a perspective view of an iPhone 6 Plus;

FIG. 2B is a partially enlarged view of area FIG. 2B of FIG. 2A;

FIG. 2C is a perspective view of an iPhone 7 Plus;

FIG. 2D is a partially enlarged view of area FIG. 2D of FIG. 2C;

FIG. 2E is a schematic diagram illustrating a proximity sensor installed in an iPhone 6 Plus in the prior art;

FIG. 2F is a schematic diagram illustrating a proximity sensor installed in an iPhone 7 Plus in the prior art;

FIG. 2G is a schematic diagram of another proximity sensor in the prior art;

FIG. 2H is a schematic diagram illustrating a conventional ambient lights sensor for installation in iPhone 6 Plus and iPhone 7 Plus;

FIG. 3 is a sectional view of the present invention;

FIG. 4 is a top plan view of the present invention;

FIG. 5 is a schematic diagram of the present invention;

FIG. 6 is a practical application view of the present invention; and

FIG. 7 is a curve diagram illustrating the wavelength and energy amounts received by the ambient lights detection chip and the proximity sensor.

### DETAILED DESCRIPTION OF THE PREFERRED EMBODIMENT

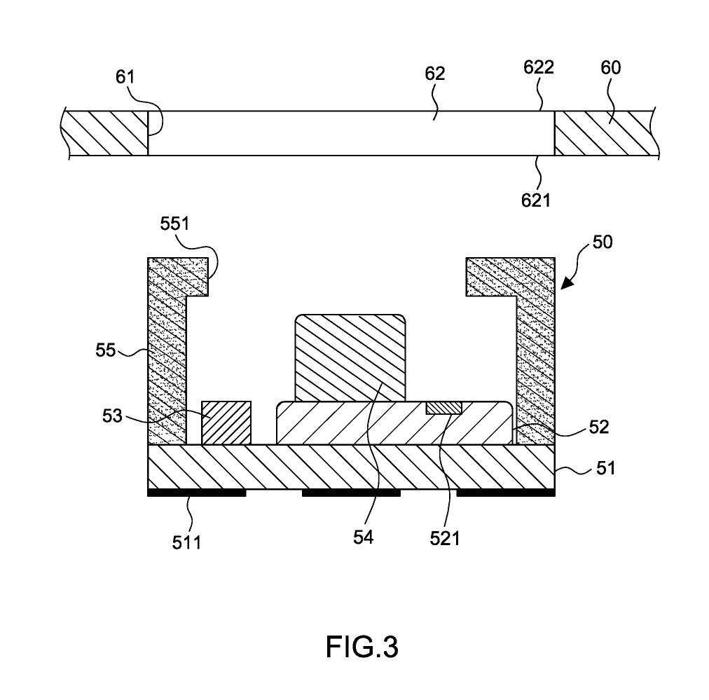

Referring to FIGS. 3-7, the present invention, a complex optical proximity sensor 50, is illustrated in a preferred embodiment. The complex optical proximity sensor 50 is disposed in a smartphone 60 under an opening hole 61 of the smartphone 60. The complex optical proximity sensor 50 includes substrate 51, an application-specific integrated circuit (ASIC) chip 52, a vertical-cavity surface-emitting laser (VCSEL) 53, an ambient lights detection chip 54, and a package body 55.

The substrate 51 is a ceramic substrate or a PCB. The ASIC chip 52 is coupled to the substrate 51 via an electric wire and has a proximity sensor 521 connected thereto. In this embodiment, the proximity sensor 521 is either coupled to or installed on the ASIC chip 52.

The vertical-cavity surface-emitting laser (VCSEL) 53 is coupled to the substrate 51 via an electric wire in linear alignment with the proximity sensor 521. The VCSEL 53 emits laser beam with a first wavelength and a first energy received by the proximity sensor 521. The laser beam is invisible to human eyes and can be divided into short-wavelength infrared ranging 850 nm-950 nm and long-wavelength infrared ranging 1300 nm-1550 nm. In another embodiment, the VCSEL 53 is coupled to the ASIC chip 52 and operates the same.

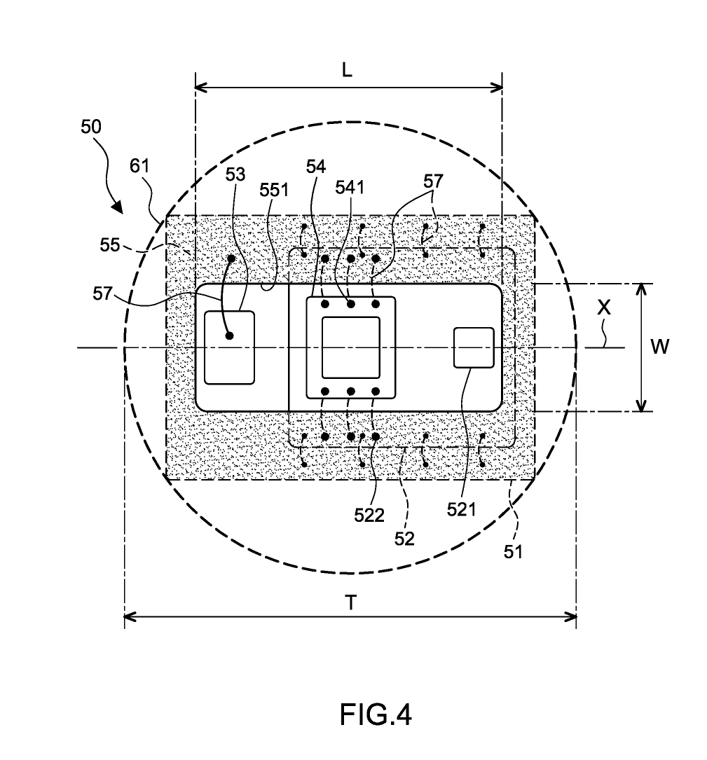

The ambient light detection chip 54 is separately manufactured and then coupled to the ASIC chip 52. The ambient light detection chip 54 stands a pre-determined height independently on the ASIC chip 52 and is disposed between the VCSEL 53 and the proximity sensor 521 in linear alignment along an X-axis X as shown in FIG. 4, therefore forming a self-integrated barrier in-between the VCSEL 53 and the proximity sensor 521. In addition, the ambient light detection chip 54 receives lights with a second wavelength and a second energy; the lights are visible to human eyes, ranging from 380 nm-760 nm. In this embodiment, the ambient lights detection chip 54 detects ambient lights S, RGB lights, or UV lights.

Furthermore, the ASIC chip 52 s detection chip includes a plurality of first connect points 522 coupled to a plurality of corresponding second connect points 541 on the ambient lights detection chip 54 for electric connection. Besides, the substrate 51 has electric wires therein for the ASIC chip 52 and the VCSEL 53 to be connected by coupling. With reference to FIG. 3, the substrate 51 includes a plurality of bond pads 511 arranged under a bottom thereof to be coupled to the ASIC chip 52 and the VCSEL 53 within the substrate 51, making the complex optical proximity sensor 50 a surface-mount device.

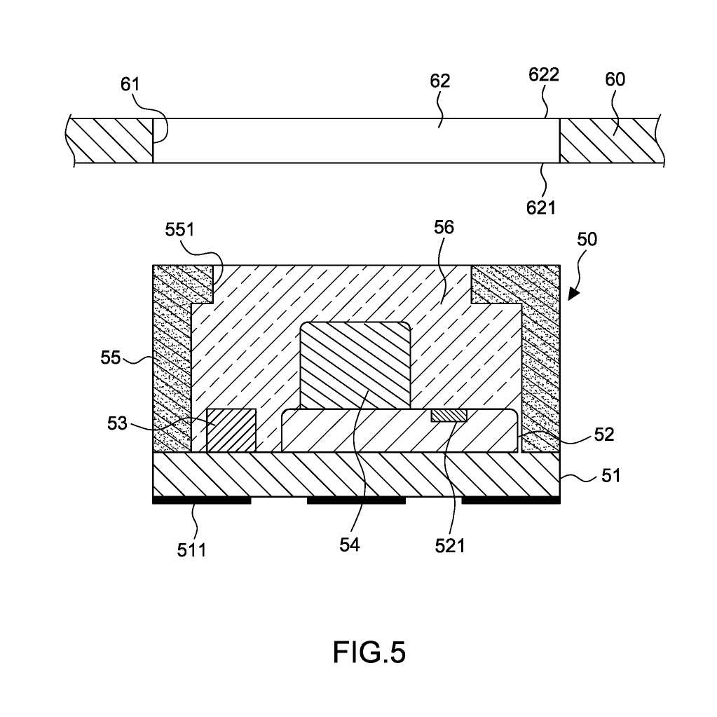

The package body 55 encapsulates the ASIC chip 52, proximity sensor 521, VCSEL 53, and ambient lights detection chip 54 on the substrate 51. The package body 55 further includes an oblong hole 551 in a middle section at a top thereof to expose the ambient lights detection chip 54 as shown in FIG. 4. The oblong hole 551 has a length L and a width W arranged less than a diameter of the opening hole 61, and the ambient lights detection chip 54 is exposed at a center of the oblong hole 551 as the self-integrated barrier, displaying a symmetric detection angle about the ambient lights detection chip 54. In this embodiment, the package body 55 is a cap. Further referring to FIG. 5, the package body 55 includes a transparent package 56 filling up the oblong hole 551 and covering the ASIC chip 52, proximity sensor 521, VCSEL 53, and ambient lights detection chip 54 within the package body 55; in the embodiment, the transparent package 56 is a lens.

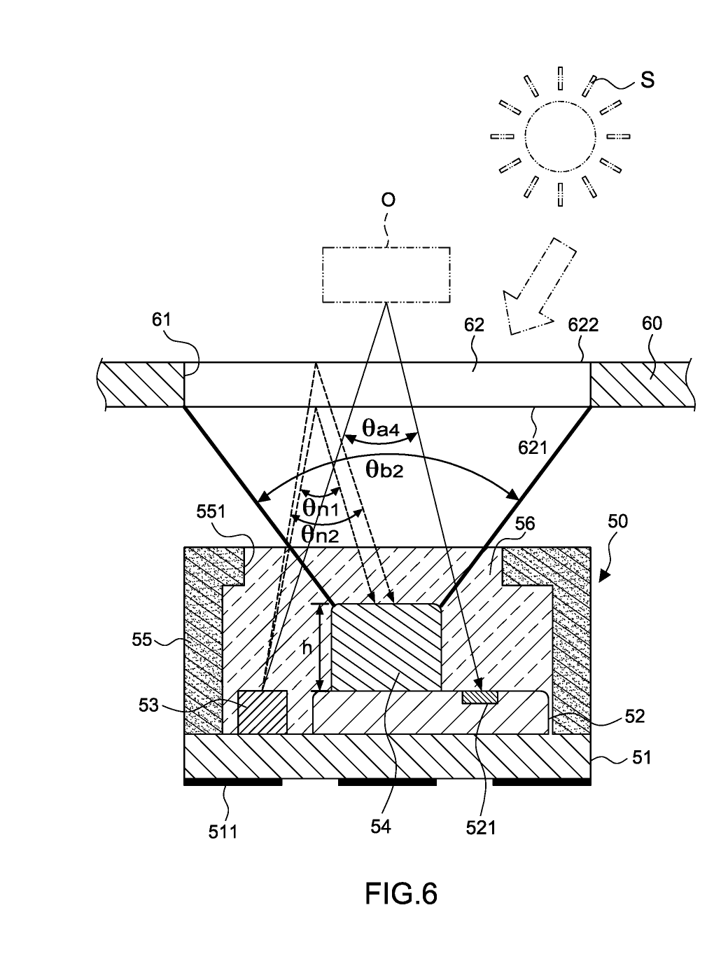

FIG. 6 illustrated the present invention in a practical application. The present invention is disposed in a smartphone 60 under an opening hole 61; the opening hole 61 further has a glass layer 62 filled therein. The present invention has the independent ambient lights detection chip 54 with pre-determined height installed on the ASIC chip 52, has the VCSEL 53, the ambient lights detection chip 54 and the proximity sensor 521 arranged in linear alignment, and has the first and second wavelength separately received by the corresponding proximity sensor 521 and ambient lights detection chip 54. When the VCSEL 53 emits laser beam from a light source to an object O, the laser beam is reflected to the proximity sensor 521 by the object O at a reflection angle θₐ₄. Also, the laser beam is reflected by a first surface 621 of the glass layer 62 at a first angle θₙ₁ and is reflected by a second surface 622 of the glass layer 62 at a second angle θₙ₂. With the ambient lights detection chip 54 being the self-integrated barrier at pre-determined height h, the laser beam reflected by the first and second surfaces 621, 622 can be blocked by the ambient lights detection chip 54 to avoid interference with the proximity sensor 521. Besides, the ambient lights detection chip 54 is disposed at a center of the opening hole 61 in order to maximize a detection angle θ_{b2} of ambient lights S. And the opening hole 61 is arranged in a circular shape to be displayed as an aperture on the smartphone 60. The ASIC chip 52 is further able to receive luminous flux of the light source and ambient lights S and to control operation of the VCSEL 53, ambient lights detection chip 54, and the proximity sensor 521.

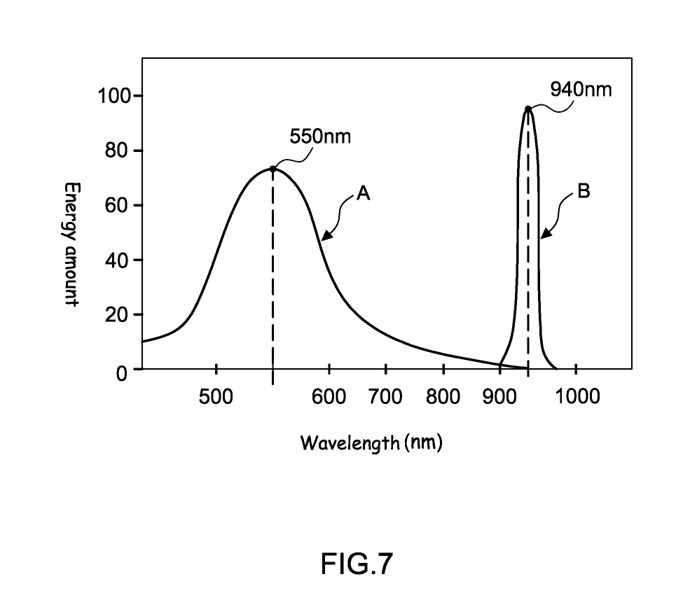

In FIG. 7, a curve A illustrated ambient lights S with the second wavelength received by the ambient lights detection chip 54 produces the second energy when the wavelength is preferably 550 nm, and a curve B illustrated laser beam with the first wavelength emitted by the VCSEL 53 produces the first energy when the wavelength is preferably 940 nm. Although the reflection angle θₐ₄ of the laser beam is overlapped with the detection angle θ_{b2} of ambient lights S, the laser beam reflected by the first and second surfaces 621, 622 of the glass layer 62 would not interfere with the detections.

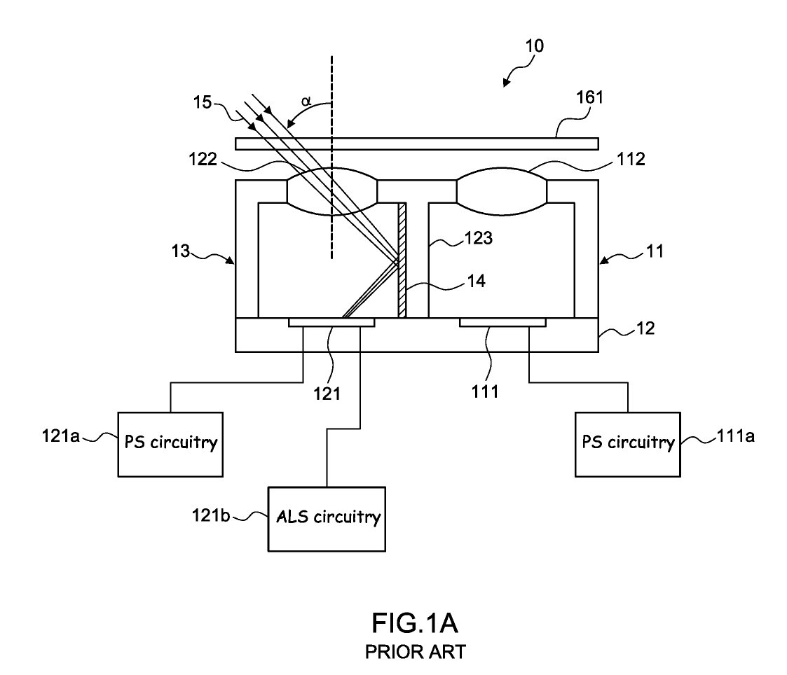

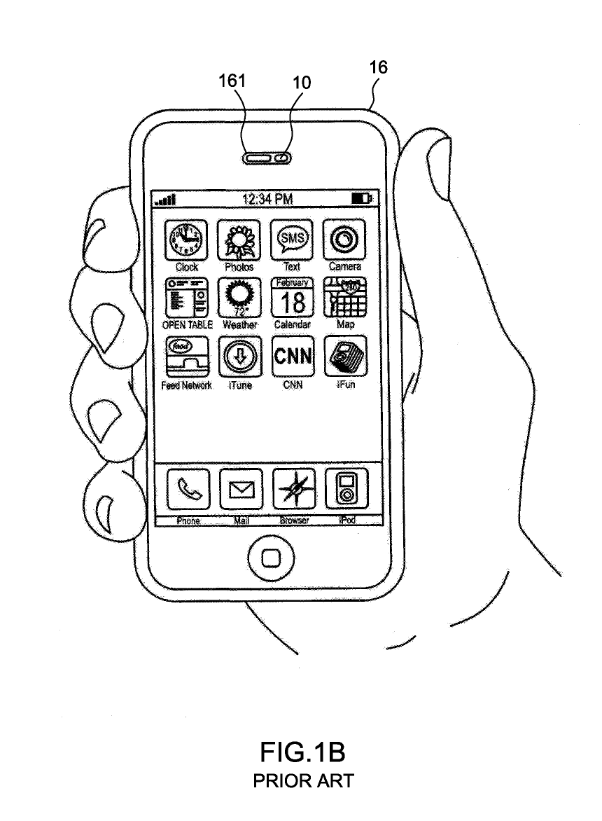

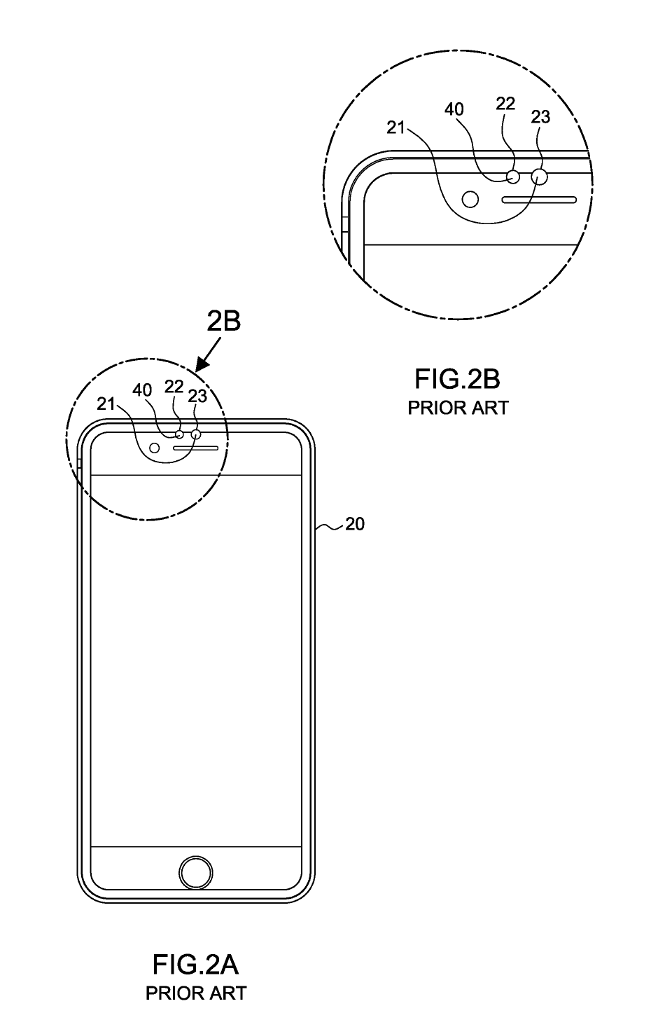

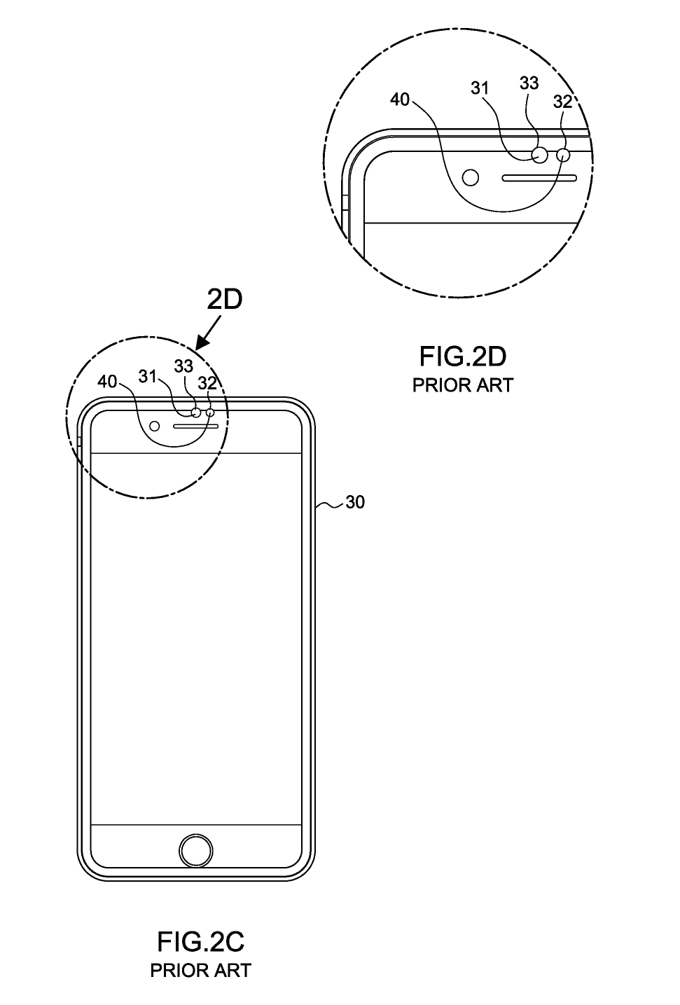

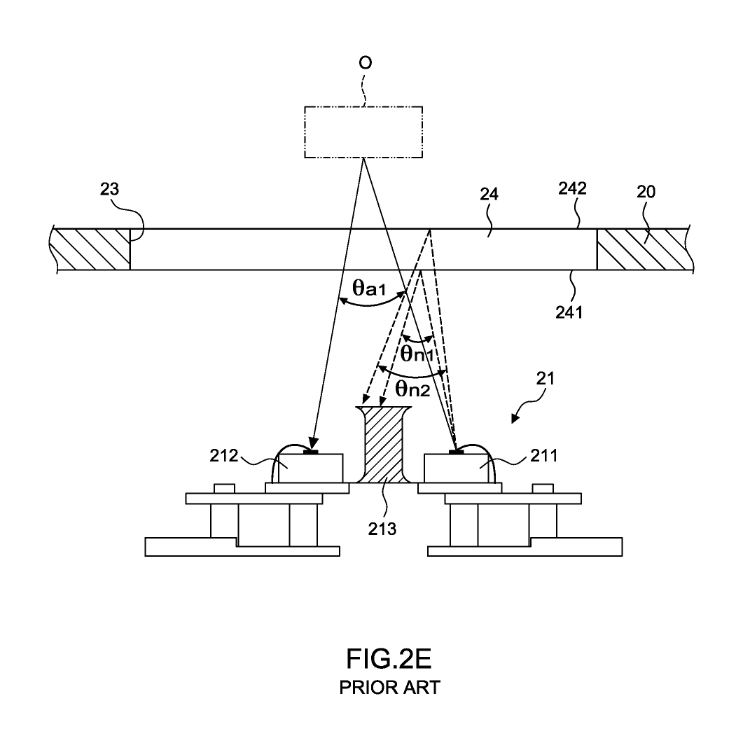

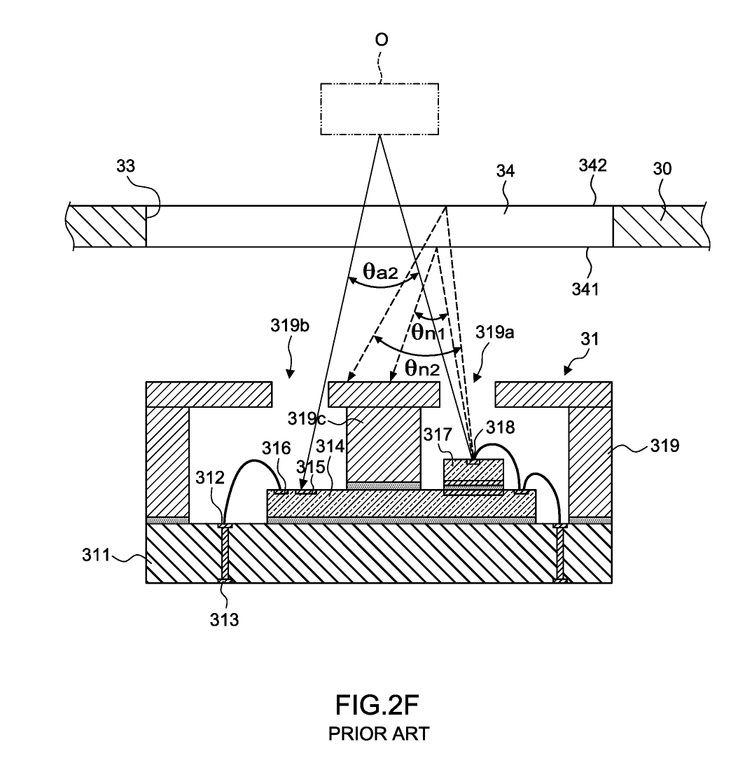

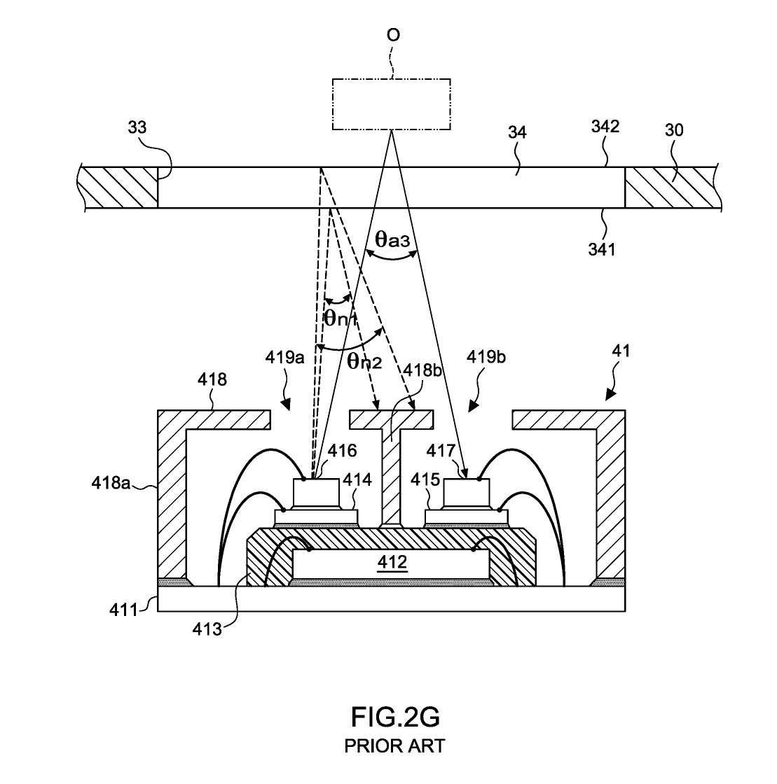

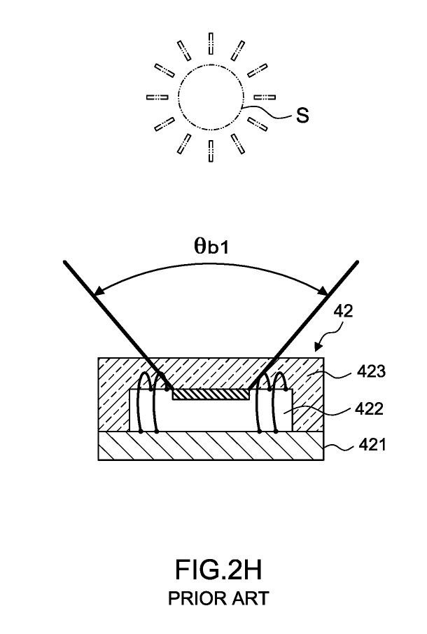

The chart below further illustrates comparisons of ALS and PS structures between the present invention, iPhone 4, iPhone 6 Plus, and iPhone 7 Plus.

| | A. Structures | B. Structures | C. Structures | |
|---|---|---|---|---|
| | installed on | installed on | installed on | |
| | iPhone 4 | iPhone 6Plus | iPhone 7 Plus | |
| | (shown in | (shown in | (shown in | |
| | FIGS. 1A and | FIGS. 2A, 2B, | FIGS. 2C, 2D, | D. The present |
| | 1B) | 2E, and 2H) | 2F, and 2G) | invention |
| Numbers and | One oblong | Two circular | Two circular | One circular |
| shapes of | opening | openings | openings | opening |
| opening(s) | | | | |
| ALS detection | Narrow | Medium | Medium | Wide |
| angle | | | | |
| Barrier | Extra element | Extra element | Extra element | Self-integration |
| structure | | | | |
| Interferences | Yes | None | None | None |
| between the | | | | |
| ALS and PS | | | | |
| structures | | | | |
| Prime costs | Low | High | High | Low |
| Space required | Medium | Large | Large | Little |
| for installation | (complex | (two | (two | (complex |
| | module with | independent | independent | module with |
| | extra barrier) | modules) | modules) | self-integrated |
| | | | | barrier) |

From the chart above we can learn that whether the ALS structure and the PS structure interferes with each other is an important factor in smartphones, considering the development in a later structure B and C installed on iPhone 6 Plus and 7 Plus. Even with higher prime costs, such structure is still used to replace previous structure A installed on iPhone 4. On the other hand, the present invention has ALS and PS structures integrated into a complex structure module without extra arrangement of a barrier to achieve a small volume of the complex optical proximity sensor 50, consuming less space required for installation and less prime costs for manufactures. Meanwhile, structures of the present invention also prevents from interferences with ALS and PS structures during operation and provides a comparatively wider angle for detection with the design of having one circular opening hole 61 on the smartphone 60 and having the ALS structure disposed right under the opening hole 61.

What is claimed is:

1. A complex optical proximity sensor installed in a mobile device under an opening hole, comprising:
a substrate;
an application-specific integrated circuit chip coupled to the substrate and connected to a proximity sensor thereon;
a vertical-cavity surface-emitting laser coupled to the substrate in linear alignment with the proximity sensor, said vertical-cavity surface-emitting laser emitting laser beam with a first wavelength and a first energy received by the proximity sensor;
an ambient lights detection chip manufactured separately and then coupled to the application-specific integrated circuit chip, said ambient lights detection chip receiving lights with a second wavelength and a second energy,
wherein the ambient lights detection chip stands a pre-determined height independently on the application-specific integrated circuit chip and is disposed between the vertical-cavity surface-emitting laser and the proximity sensor in linear alignment, forming a self-integrated barrier in-between the vertical-cavity surface-emitting laser and the proximity sensor; and
a package body encapsulating the application-specific integrated circuit chip, proximity sensor, vertical-cavity surface-emitting laser, and ambient lights detection chip on the substrate, said package body including an oblong hole in a middle section at a top thereof to expose the ambient lights detection chip;
whereby the independent ambient lights detection chip with pre-determined height on the application-specific integrated circuit chip, the linear aligning arrangement of the vertical-cavity surface-emitting laser, the ambient lights detection chip and the proximity sensor, and the setting of the first and second wavelength being separately received by the corresponding proximity sensor and ambient lights detection chip prevent the vertical-cavity surface-emitting laser from interfering with the proximity sensor, and the design of the ambient lights detection chip being exposed in the oblong hole allows a maximized angle for ambient lights detection.

2. The complex optical proximity sensor as claimed in claim 1, wherein the first wavelength is 940 nm and the second wavelength is 550 nm.

3. The complex optical proximity sensor as claimed in claim 1, wherein the package body is a cap.

4. The complex optical proximity sensor as claimed in claim 3, wherein the package body further includes a transparent package filling up the oblong hole and covering the application-specific integrated circuit chip, proximity sensor, vertical-cavity surface-emitting laser, and ambient lights detection chip within the package body.

5. The complex optical proximity sensor as claimed in claim 4, wherein the transparent package is a lens.

6. The complex optical proximity sensor as claimed in claim 1, wherein the ambient lights detection chip detects ambient lights, RGB lights, or UV lights.

7. The complex optical proximity sensor as claimed in claim 1, wherein the substrate is either a ceramic substrate or a PCB for the application-specific integrated circuit chip and the vertical-cavity surface emitting laser to be connected by coupling, and the application-specific integrated circuit chip has a plurality of first connect points coupled to a plurality of corresponding second connect points on the ambient lights detection chip.

8. The complex optical proximity sensor as claimed in claim 7, wherein the substrate includes a plurality of bond pads arranged under a bottom thereof to be coupled to the application-specific integrated circuit chip and the vertical-cavity surface emitting laser, making the complex optical proximity sensor a surface-mount device.

9. The complex optical proximity sensor as claimed in claim 1, wherein the proximity sensor is connected to the application-specific integrated circuit chip either by coupling or installation.

10. The complex optical proximity sensor as claimed in claim 1, wherein the oblong hole has a length and a width arranged less than a diameter of the opening hole and the ambient lights detection chip is exposed at a center of the oblong hole as the self-integrated barrier, displaying a symmetric detection angle about the ambient lights detection chip.
